(19) United States
(12) Patent Application Publication
(10) Pub. No.: US 2004/0135498 A1
(43) Pub. Date: Jul. 15, 2004

(54) Organic electroluminescence panel and method for manufacturing the same

(76) Inventors: Keiji Takanosu, Yokohama (JP); Eiji Matsuzaki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/751,531

(22) Filed: Jan. 6, 2004

(30) Foreign Application Priority Data
Jan. 9, 2003 (JP) 2003-003132
Sep. 5, 2003 (JP) 2003-313714

(51) Int. Cl. H05B 33/00

(52) U.S. Cl. 313/504; 313/506

(57) ABSTRACT

At least one of an organic emitting layer, an electron injection layer and an electron transfer layer for pixels of an organic electroluminescence panel is formed from a deposition material by deposition via mask holes of a multilayer metal mask. The multilayer metal mask has a first metal layer on the side of a transparent substrate for forming the organic electroluminescence panel and a second metal layer on the side of a supply source of the deposition material, which metal layers are different in material. The second metal layer is made of a thick plate of magnetic material. The area of each first mask hole of the first metal layer is made equal to or smaller than that of each second mask hole of the second metal layer. Such a configuration can provide a metal mask forming organic electroluminescence devices with high reliability, high mechanical strength and high performance. Thus, a high-definition and high-quality organic electroluminescence display panel can be realized.

### BACKGROUND OF THE INVENTION

The present invention relates to a display device, and particularly relates to a method for manufacturing an organic electroluminescence panel high in definition and excellent in productivity, and an organic electroluminescence panel manufactured in the manufacturing method.

An organic electroluminescence (EL) panel is to display an image with organic EL devices disposed two-dimensionally and driven by a current. Each organic EL device typically has a laminated structure of organic materials including a hole transfer layer, a hole injection layer, an emitting layer, an electron injection layer, an electron transfer layer and the like on a transparent substrate such as a glass plate. The organic EL device is constituted by a pair of electrodes having the laminated structure put therebetween for allowing a formed current to flow into the laminated structure. At least one of the paired electrodes is transparent. More specifically, the organic EL device is a capacitive display device as follows. That is, a hole transfer layer, a hole injection layer, an emitting layer, an electron injection layer and an electron transfer layer are laminated on a first electrode (typically an anode) formed for each pixel on a transparent substrate, and further covered with a second electrode (typically a cathode) A current is applied between the first and second electrodes, and the emission luminance is controlled by the current density. Such organic EL devices (hereinafter also referred to as “devices” simply) are disposed in a two-dimensional pattern so as to arrange a display device, that is, an organic EL panel.

A display device is arranged with the organic EL panel in combination with functional parts such as a drive circuit and the like. Organic EL panels are categorized into a passive matrix type and an active matrix type. In the passive matrix type, a plurality of first electrodes and a plurality of second electrodes are crossed to form pixels in the crossing portions respectively. In the active matrix type, an active device such as a thin film transistor is provided for each pixel, and a first electrode to be driven by the active device is provided. The active matrix type prevails due to its resolution or high-speed display. Description will be made below taking the active matrix type for instance.

The aforementioned respective layers to be formed on the transparent substrate are formed by deposition using a mask made from a metal material and referred to as a so-called metal mask. In the background art, the metal mask for forming an organic EL panel is produced in the following procedure, for example, as disclosed in JP-A-2001-237072 (pages 2-6, FIG. 2).

First, a first resist pattern having a plurality of through apertures is formed on a metal plate. Etching is performed through the through apertures of the first resist pattern so as to form a plurality of through apertures in the metal plate. After that, the first resist pattern is removed from the metal plate, and a second resist pattern having a plurality of second through apertures is formed on the metal plate so that metal edge portions around the plurality of through apertures are exposed with a predetermined width from the second through apertures respectively. Next, etching is performed through each of the plurality of second through apertures of the second resist pattern so as to form a mask body portion around the second through aperture and a circumferential edge portion located around the mask body portion and having a thickness larger than the thickness of the mask body portion. Then, the second resist pattern is removed. Thus, a metal mask is obtained.

Using the metal mask, necessary organic EL constituent layers are formed sequentially on the transparent substrate having active devices (which will be regarded as thin film transistors below for explanation) and first electrodes to be driven by the active devices, so as to form a laminated structure. Second electrodes are coated as the outermost layer so as to serve as counter electrodes to the first electrodes. Thus, an organic EL panel is arranged.

### SUMMARY OF THE INVENTION

According to the aforementioned conventional technique for manufacturing a metal mask for manufacturing an organic EL panel, through aperture portions of a pattern are formed by two steps of etching or two steps of electroforming. In the case of etching, in the first step of etching, it is generally difficult to make the through aperture size smaller than the thickness of an etched plate material. On the other hand, in the case of electroforming, it is difficult to control the sectional shape of each aperture portion, and it is difficult to give the aperture portion a tilt angle advantageous to oblique deposition. It is therefore difficult to make the pixel pattern of organic EL devices have high definition and high performance. Further, it takes much time for a precipitation step in the second step. It is therefore difficult to increase the productivity of the metal mask.

Therefore, there is a limit to reduction in the manufacturing cost of an organic EL panel using such a metal mask. Thus, the improvement of the manufacturing accuracy of the manufactured organic EL panel is limited. It is therefore difficult to obtain a high-definition and high-quality organic EL panel.

It is an object of the present invention to solve the foregoing problems belonging to the background art. It is another object of the present invention to provide a method for manufacturing an organic EL display panel using a metal mask for forming organic EL devices, with simple configuration, high reliability, high mechanical strength and high performance, and a high-definition and high-quality organic EL display panel manufactured in the manufacturing method.

The present invention is characterized in that a metal mask produced in the following method is used for manufacturing an organic EL panel in which a hole transfer layer, a hole injection layer, an emitting layer, an electron injection layer and an electron transfer layer are laminated on a transparent substrate so as to be put between first and second transparent electrodes required for applying a current therebetween.

That is, a metal mask for forming organic EL devices according to the present invention is comprised of a plurality of metal layers including a metal layer on the side of a transparent substrate of glass or the like for forming organic EL devices with which an organic EL panel is arranged, and a metal layer on the side of a supply source of an emitting layer material (deposition material) for forming at least one of an organic emitting layer, an electron injection layer and an electron transfer layer. These two metal layers are different in material. At least one of the metal layers other than the metal layer on the side of the transparent substrate is made of a thick plate (bulk material) of a magnetic material, while the area of each mask hole of the metal layer on the side of the transparent substrate is equal to or smaller than the area of each mask hole of the metal layer on the side of the supply source of the emitting layer material of the organic EL devices.

In addition, the metal mask for forming organic EL devices according to the present invention is adapted so that the portion of each mask hole of the metal layer on the side of the supply source of the emitting layer material has a section having a tilt angle not smaller than 30 degrees and not larger than 85 degrees, and the metal layer on the side of the transparent substrate for the organic EL devices is thinner than the metal layer on the side of the supply source of the emitting layer material. Then, smaller one of the longitudinal size and the crosswise size of each mask hole portion of the metal layer on the side of the supply source of the emitting layer material is made not smaller than 5 micrometers and not larger than 50 micrometers, while the aperture portions of the metal layer on the side of the transparent substrate are made to have longitudinal and crosswise sizes corresponding to the pixels of the organic EL devices respectively.

Further, each mask hole portion of the metal layer on the side of the supply source of the emitting layer material is made to have a longitudinal size corresponding to a plurality of pixels, and the metal layer on the side of the transparent substrate is formed in an additive method, while the metal layer on the side of the supply source of the emitting layer material is formed in a subtractive method.

In addition, the metal mask for forming organic EL devices according to the present invention may be formed in a manner different from the aforementioned manner. That is, the metal layer on the side of the transparent substrate and the metal layer on the side of the supply source of the emitting layer material are formed by sintering and laminating metal powder into a predetermined shape by a laser in turn. According to further another method for manufacturing the metal mask, the metal layer on the side of the transparent substrate and the metal layer on the side of the supply source of the emitting layer material may be formed by elimination processing using a micro electrical discharge machining method for forming a metal plate into a predetermined shape.

The method in which at least one of the hole transfer layer, the hole injection layer, the emitting layer, the electron injection layer and the electron transfer layer is deposited using the metal mask for forming organic EL devices manufactured in a simple method as described above is high in reliability and excellent in productivity. In addition, when at least one of the hole transfer layer, the hole injection layer, the emitting layer, the electron injection layer and the electron transfer layer is deposited using the metal mask, a high-definition and high-quality organic EL panel can be obtained.

A representative configuration of a method for manufacturing an organic EL panel according to the present invention will be described below. That is, the manufacturing method according to the present invention is to manufacture an organic EL panel including a transparent substrate having a first electrode layer and an insulating layer formed on the first electrode layer, the first electrode layer being comprised of pieces formed to correspond to a plurality of pixels and to be driven by active devices respectively, the insulating layer having rectangular apertures corresponding to the pixels respectively, the pieces of the first electrode layer being exposed from the rectangular apertures respectively; a hole transfer layer and a hole injection layer formed correspondingly to the plurality of pixels so as to be laminated sequentially on the pieces of the first electrode layer through the rectangular apertures; an organic emitting layer comprised of pieces formed on the hole injection layer correspondingly to the pixels respectively; an electron injection layer and an electron transfer layer formed sequentially so as to be laminated on the organic emitting layer; and a second electrode layer formed on the electron transfer layer over the plurality of pixels in common. The manufacturing method is characterized by including the step of forming at least one of the organic emitting layer, the electron injection layer and the electron transfer layer out of a deposition material by deposition via a multilayer metal mask disposed in close contact with the insulating layer of the transparent substrate.

Then, the multilayer metal mask used in the manufacturing method according to the present invention is characterized in that, of a plurality of metal layers of the multilayer metal mask, a metal layer on the side of the transparent substrate and a metal layer on the side of a supply source of the deposition material are different in material, and at least one of the metal layers other than the metal layer on the side of the transparent substrate is made of a thick plate of a magnetic material, while the area of each mask hole of the metal layer on the side of the transparent substrate is equal to or smaller than the area of each mask hole of the metal layer on the side of the supply source of the deposition material.

In addition, the multilayer metal mask is characterized in that an inner wall of each mask hole portion of the metal layer on the side of the supply source of the deposition material has a funnel-like shape having a tilt angle not smaller than 30 degrees and not larger than 85 degrees, and open to the side of the supply source of the deposition material.

Further, the multilayer metal mask is characterized in that the metal layer on the side of the transparent substrate is thinner than the metal layer on the side of the supply source of the deposition material.

In addition, the multilayer metal mask is characterized in that the mask holes of the metal layer on the side of the transparent substrate has longitudinal and crosswise sizes corresponding to the pixels respectively, while each mask hole of the metal layer on the side of the supply source of the deposition material has a longitudinal size including a plurality of the pixels in common.

A representative configuration of an organic EL panel manufactured in the aforementioned manufacturing method according to the present invention will be described below.

That is, the organic EL panel includes a transparent substrate having a first electrode layer and an insulating layer formed on the first electrode layer, the first electrode layer being comprised of pieces formed to correspond to a plurality of pixels and to be driven by active devices respectively, the insulating layer having rectangular apertures corresponding to the pixels respectively, the pieces of the first electrode layer being exposed from the rectangular apertures respectively; a hole transfer layer and a hole injection layer formed correspondingly to the plurality of pixels so as to be laminated sequentially on the first electrode layer through the rectangular apertures; an organic emitting layer comprised of pieces formed on the hole injection layer correspondingly to the pixels respectively; an electron injection layer and an electron transfer layer formed sequentially so as to be laminated on the organic emitting layer; and a second electrode layer formed on the electron transfer layer over the plurality of pixels in common. The organic EL panel is characterized in that each short side of the rectangular apertures is not longer than 14 micrometers, while each long side thereof is not longer than 42 micrometers.

Further, the organic EL panel according to the present invention is characterized in that each piece of the organic emitting layer formed for each pixel on the hole injection layer and each piece of the electron injection layer and the electron transfer layer formed and laminated on the organic emitting layer are larger than each of the rectangular apertures exposing the first electrode layer therefrom, and a curvature radius of each corner portion of the rectangular apertures is not larger than 5 micrometers.

In addition, the organic EL panel according to the present invention is characterized in that a pitch of the pixels formed in the rectangular apertures respectively is not longer than 69 micrometers along the long sides of the rectangular apertures and not longer than 23 micrometers along the short sides of the rectangular apertures.

Incidentally, the present invention is not limited to the aforementioned configurations of the manufacturing methods and the organic EL panels or the configurations of manufacturing methods and organic EL panels disclosed in embodiments which will be described later. Not to say, various modifications can be made therein without departing from the technical idea of the present invention.

The multilayer metal mask according to the present invention is high in reliability in spite of its simple configuration. When an emitting layer or the like is formed using the multilayer metal mask, a high-definition organic EL panel can be obtained. Then, when the obtained organic EL panel is incorporated, a high-quality organic EL display device can be realized.

### BRIEF DESCRIPTION OF THE DRAWINGS

These and other features, objects and advantages of the present invention will become more apparent from the following description when taken in conjunction with the accompanying drawings wherein:

FIG. 1 is a sectional view showing the configuration of a multilayer metal mask to be used for manufacturing an organic EL panel according to an embodiment of the present invention;

FIGS. 2A-2F are sectional views typically showing a process for manufacturing one surface of the multilayer metal mask to be used for manufacturing the organic EL panel according to the embodiment of the present invention;

FIGS. 3A-3F are sectional views typically showing a process for manufacturing the other surface of the metal mask to be used for organic EL devices according to the embodiment of the present invention;

FIG. 4 is a schematic view typically showing a resist exposure mask of the metal mask to be used for organic EL devices according to the present invention;

FIG. 5 is an enlarged sectional view typically showing the multilayer metal mask according to the embodiment;

FIGS. 6A and 6B are conceptual views of a multilayer metal mask to be used for deposition of a green emitting layer or the like of the organic EL panel according to the present invention, and pixel apertures which are aperture portions of an insulating film on a transparent substrate forming the organic EL panel;

FIGS. 7A and 7B are conceptual views of a multilayer metal mask to be used for deposition of a blue emitting layer or the like of the organic EL panel according to the present invention, and the pixel apertures which are the aperture portions of the insulating film on the transparent substrate forming the organic EL panel;

FIGS. 8A and 8B are conceptual views of a multilayer metal mask to be used for deposition of a red emitting layer or the like of the organic EL panel according to the present invention, and the pixel apertures which are the aperture portions of the insulating film on the transparent substrate forming the organic EL panel;

FIGS. 9A and 9B are plan views for explaining the state of a failure in deposition on a pixel aperture in accordance with the radius (R) size of a corner portion of a multilayer metal mask according to the present invention;

FIG. 10 is an explanatory view of a method for manufacturing an organic EL panel according to the present invention;

FIG. 11 is a partial plan view of an organic EL panel, showing an example of an array of pixels formed by use of a multilayer metal mask according to the present invention;

FIG. 12 is a partial plan view of an organic EL panel for explaining another example of an array of sub-pixels constituting a color pixel on the organic EL panel according to the present invention; and

FIG. 13 is an explanatory view of an example of a high-definition organic EL display device in which an organic EL panel manufactured according to the present invention has been incorporated.

### DETAILED DESCRIPTION OF PREFERRED EMBODIMENTS

Embodiments of the present invention will be described below in detail with reference to the drawings. First, description will be made on a multilayer metal mask for forming organic EL devices. After that, description will be made on a method for manufacturing an organic EL panel using this multilayer metal mask, and the configuration of the manufactured organic EL panel.

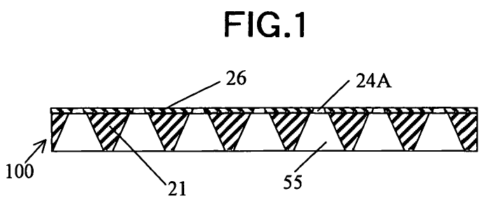

FIG. 1 is a sectional view showing the configuration of a multilayer metal mask to be used for manufacturing an organic EL panel according to an embodiment of the present invention. As shown in FIG. 1, a multilayer metal mask 100 for forming an organic EL panel according to the present invention is constituted by a first layer 26 forming one surface thereof and a second layer 21 forming the other surface thereof. The first layer 26has first mask holes 24A, which are small aperture portions formed by an electroforming method that is one of additive methods. The second layer 21 has second mask holes 55, which are large aperture portions formed in a thick plate of a magnetic material by an etching process that is one of subtractive methods.

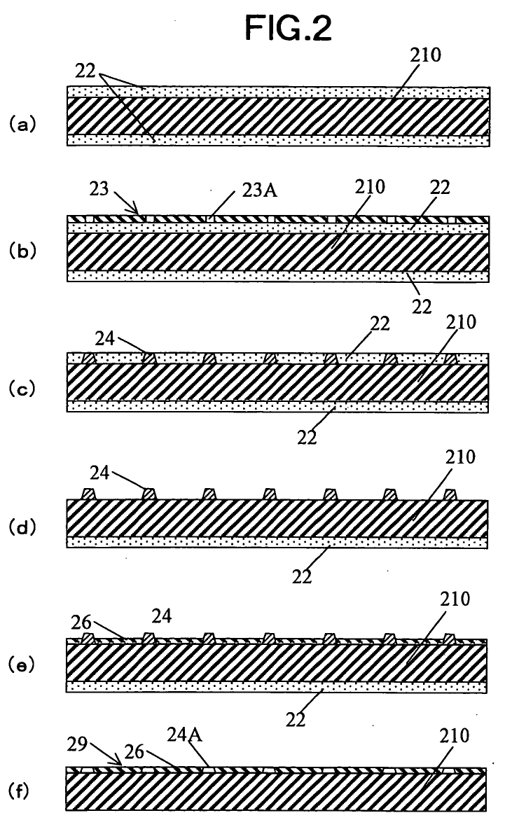

FIGS. 2A-2F are sectional views typically showing a process for manufacturing one surface of the multilayer metal mask to be used for manufacturing an organic EL panel according to the embodiment of the present invention. Incidentally, it can be noted that the following specific numerical values are merely taken for instance. In the multilayer metal mask, as shown in FIG. 2A, a resist 22 is first applied to the both sides of a 42 alloy (42% nickel-iron alloy) plate 210 as a substrate 30 micrometers thick, which plate 210 will serve as the second layer 21. Then, as shown in FIG. 2B, a first exposure mask 23 having small aperture portions 23A is brought into close contact with one surface (top surface in FIG. 2B) of the 42 alloy plate 210.

After that, as shown in FIG. 2C, the first exposure mask 23 is irradiated with ultraviolet light so that the resist 22 exposed through the aperture portions 23A is exposed to the light. The resist 22 is developed so that unexposed resist is removed. Thus, first convex shapes 24 for producing the first mask holes of the multilayer metal mask for forming the pattern of the organic EL panel are patterned (FIG. 2D). The shape of the multilayer metal mask at this time is identical to a final deposition pattern defining the shape of organic EL devices.

Next, the 42 alloy plate 210 as a substrate where the first convex shapes 24 have been formed is put into a solution tank receiving a solution containing nickel ions. A current is applied between an anode provided in the solution tank and the 42 alloy plate 210 whose both sides have been coated with the resist 22. Thus, as shown in FIG. 2E, a nickel layer 26 is electrodeposited to the surface of the 42 alloy plate 210 where the first convex shapes 24 have been formed.

The 42 alloy plate 210 is immersed in a bath of resist stripper such as hydrogen peroxide solution, so as to strip and remove the first convex shapes 24 of the resist and the resist 22 applied to the other surface (bottom surface in FIG. 2E) of the 42 alloy plate 210. Thus, an intermediate substrate 29 in which the 42 alloy plate 210 has been integrated with the nickel layer 26 having the first mask holes 24A serving as apertures having a pattern capable of depositing the shape of organic EL devices finally can be obtained as shown in FIG. 2F.

Incidentally, as for the pixel pattern (device pattern) of the high-definition organic EL panel in this embodiment, each pixel aperture formed in the transparent substrate is a slot-like aperture (rectangular aperture) having long sides in one direction and short sides in another direction. Here assume that the short side size of each slot-like pixel aperture is set at 14 micrometers, and the long side size thereof is set at 42 micrometers. When a color pixel is constituted by sub-pixels of three colors of red (R), green (G) and blue (B), the mask holes of the multilayer metal mask corresponding to the pixel apertures have to allow deposition all over the sub-pixels in intended color pixels without fail, and have to prevent the color of each pixel from being mixed with the color of a pixel adjacent thereto.

To this end, in this embodiment, assume that the short side size of the first mask holes 24A of the multilayer metal mask corresponding to the pixel apertures is set at 23 micrometers, and the long side size thereof is set at 60 micrometers. In general electrodeposition (or electroforming), it is difficult as a matter of working process that a smaller one of the longitudinal size (long side size) and the crosswise size (short side size) of the rectangular first mask holes 24A is not longer than a size t when the size t designates the thickness of a deposited layer. Therefore, in this embodiment, the thickness of the deposited layer is set at 23 micrometers in order to form small apertures (first mask holes) whose short side size is 23 micrometers for the sake of high definition.

Although the mask holes for forming a fine organic EL device pattern can be formed by setting such a dimensional relationship, it is highly likely that the mask will be broken because it is very difficult to handle the mask as a deposition mask when the mask is 23 micrometers thick, that is, as thick as the deposited layer. In addition, in the same manner, also in processing using etching, there is a limit to the relationship between the plate thickness and the aperture size. To form minute apertures, it is necessary to use an extremely thin substrate. However, there is no material as thin as 23 micrometers in substrates generally used as masks. It is therefore practically difficult to use such a thin substrate.

Thus, it is extremely difficult to form minute aperture portions serving as mask holes measuring 23 micrometers in short side size by etching. In this embodiment, however, the 42 alloy plate 210 serving as the substrate is used so that a high-definition multilayer metal mask having no problem in strength can be formed through the following steps. In addition, when minute aperture portions (first mask holes) are formed by an electrodeposited layer, the curvature radius (R-size) of each corner portion of the aperture portions is set to be not larger than 5 micrometers due to the excellent rectangular resist pattern accuracy.

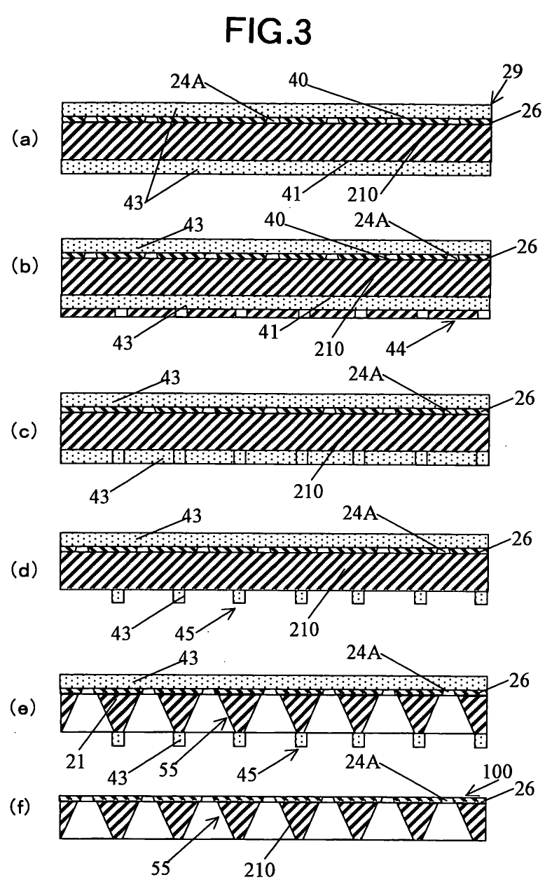

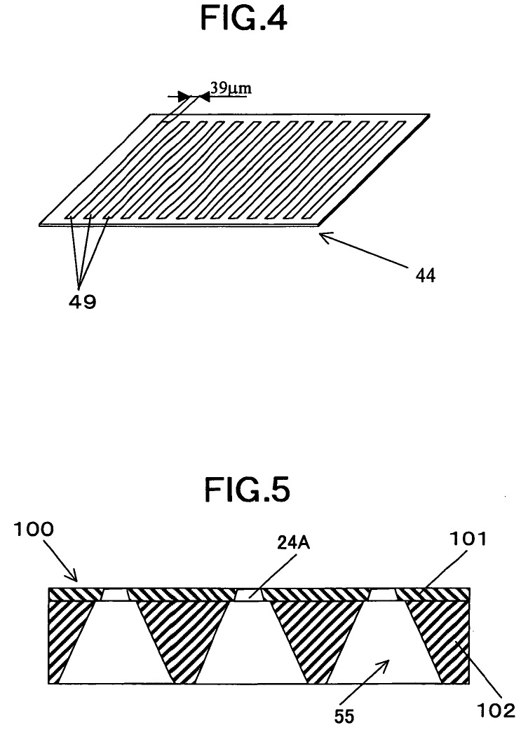

FIGS. 3A-3F are sectional views typically showing a process for manufacturing the other surface of the metal mask to be used for organic EL devices according to the embodiment of the present invention. FIGS. 3A-3F are process views for explaining the process for forming aperture portions on a surface opposite to the aforementioned surface. FIG. 4 is a schematic view typically showing a resist exposure mask, and FIG. 5 is an enlarged sectional view typically showing a multilayer metal mask in this embodiment.

First, as shown in FIG. 3A, a resist 43 is applied to whole surfaces 40 and 41 of the intermediate substrate 29 in which the 42 alloy plate 210 subjected to the aforementioned process illustrated in FIGS. 2A-2F has been integrated with the nickel layer 26 having small aperture portions, that is, the first mask holes 24A to be opposed to a transparent substrate of an organic EL panel. The surface 40 has the first mask holes 24A, and the surface 41 is opposite to the surface 40. Then, a second exposure mask 44 is brought into close contact with the surface 41 opposite to the surface 40 having the first mask holes 24A as shown in FIG. 3B, and exposure and development steps are carried out as shown in FIG. 3C.

Assume that the second exposure mask 44 used here has a large number of stripe-shaped aperture patterns 49 as shown in FIG. 4, and each stripe-shaped aperture pattern 49 measures 39 micrometers in short side. The long sides of the stripe-shaped aperture patterns 49 are parallel to the long sides of the first mask holes 24A, while the centers of the stripe-shaped aperture patterns 49 coincide with the centers of the first mask holes 24A respectively with respect to the up/down direction. Then, as shown in FIG. 3D, the resist 43 in the non-developed portion is removed so that second convex shapes 45 are formed on the surface opposite to the surface 40 having the first mask holes 24A. In this state, the portion of the 42 alloy plate 210 having no resist is etched by an etching step, so that the 42 alloy plate 210 is processed into a shape having second mask holes 55 in the second layer 21 as shown in FIG. 3E. In this event, the etching conditions are adjusted so that the inner walls of the second mask holes 55 formed in the second layer 21 are shaped to have a funnel-shaped section inclined at an angle of about 60 degrees. The long sides and the short sides of the second mask holes 55 are parallel with the long sides and the short sides of the first mask holes 24A respectively, while the centers of the second mask holes 55 coincide with the centers of the first mask holes 24A respectively. Incidentally, these first and second layers are referred to as metal layers in claims.

Finally, the resist 43 is removed with resist stripper similar to the aforementioned one, so that a metal mask (multilayer metal mask) 100 having a multilayer structure as shown in FIG. 3F is obtained. FIG. 5 shows an enlarged sectional view of the completed multilayer metal mask 100. The multilayer metal mask 100 has a structure as follows. That is, small apertures corresponding to high definition, that is, the first mask holes 24A are formed in an electrodeposited portion 101 (corresponding to the reference numeral 26 in FIGS. 2A-2F). On the other hand, the strength is secured by a second layer 102 (corresponding to the reference numeral 21 in FIGS. 2A-2F and 3A-3F) in which large aperture portions, that is, the second mask holes 55 are formed by etching, while deposition materials are allowed to pass through the multilayer metal mask 100 efficiently. Thus, uniform deposition can be carried out on the organic EL device pattern portions (pixel apertures of the transparent substrate).

Incidentally, another embodiment for manufacturing a multilayer metal mask adopts a method for forming the aforementioned metal mask 100 using a so-called rapid prototyping method. In this method, metal powder is scanned with a laser beam sequentially so as to be sintered and laminated in a predetermined shape as a metal layer (first layer, corresponding to the electrodeposited portion 101 in FIG. 5) on the side of a transparent substrate for forming an organic EL panel, and a metal layer (corresponding to the second layer 102 in FIG. 5) on the side of a supply source of an emitting layer material.

Further another embodiment for manufacturing a multilayer metal mask adopts a method in which a metal plate is formed into a predetermined shape by elimination processing using a micro electrical discharge machining method so as to form a metal layer on the side of a transparent substrate for forming an organic EL panel, and a metal layer on the side of a supply source of an emitting layer material.

Next, description will be made on an embodiment of a method for manufacturing an organic EL panel using the aforementioned multilayer metal mask. First, thin film transistors (TFTs) are formed on a transparent substrate of glass or the like in a general method used for manufacturing a liquid crystal panel. After that, a transparent electrode (ITO (Indium Tin Oxide)) film and an insulating film are formed sequentially all over the surface of the transparent substrate. Aperture portions (pixel apertures) are provided in the insulating film so as to form pixels in accordance with desired definition, and a hole transfer layer and a hole injection layer are deposited all over the surface.

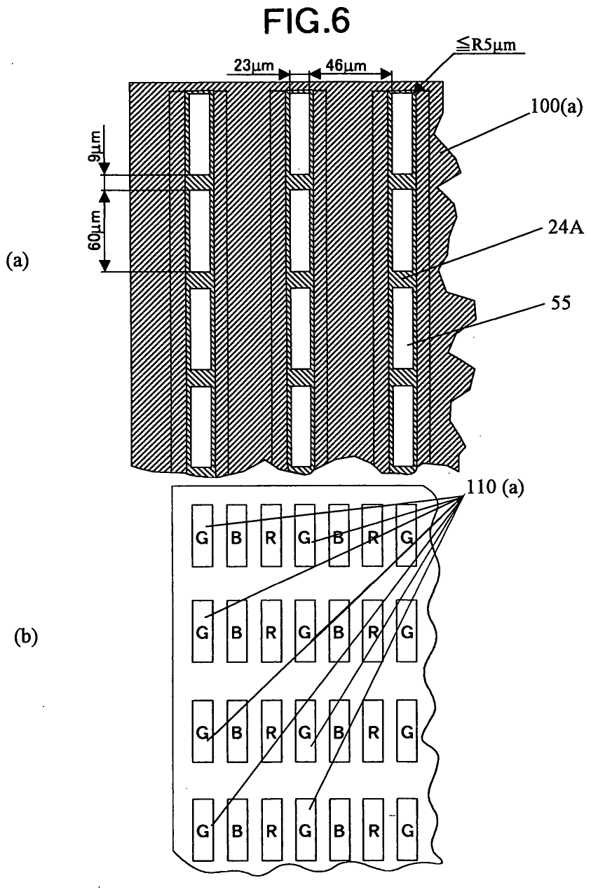

Next, using multilayer metal masks as described above, emitting layers are deposited to coat the aperture portions of the insulating film serving as pixel apertures in different three colors (green, blue and red), and an electron transfer layer, an electron injection layer and the like are deposited. The deposition will be described specifically with reference to FIGS. 6A-6B, 7A-7B, 8A-8B and 9A-9B.

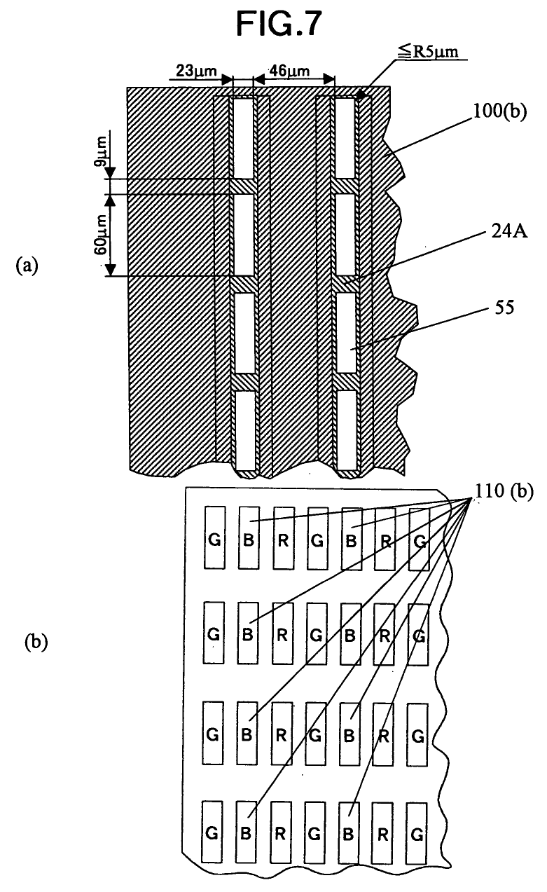

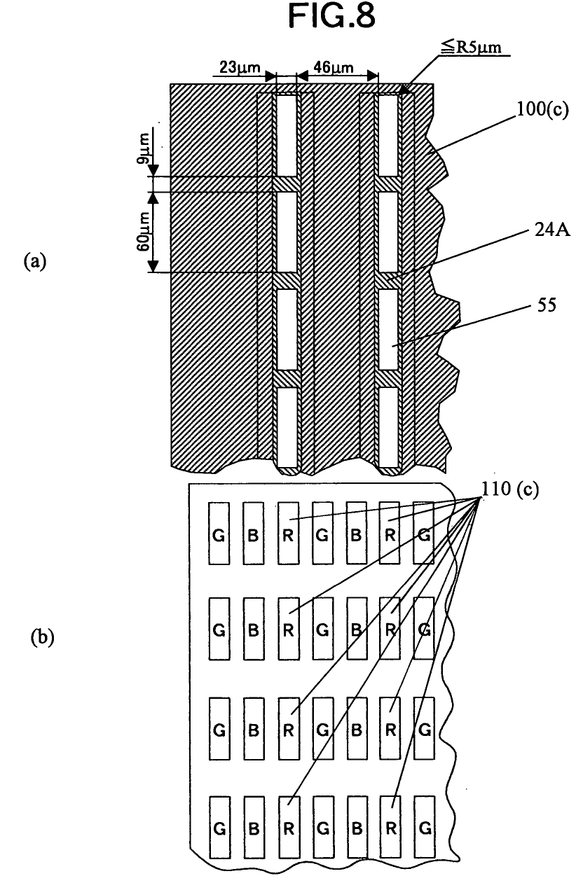

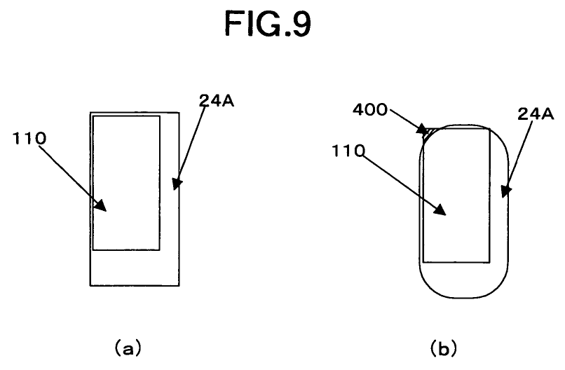

FIGS. 6A and 6B are conceptual views of a multilayer metal mask to be used for deposition of a green emitting layer and the like of the organic EL panel according to the present invention, and pixel apertures which are aperture portions of an insulating film on a transparent substrate forming the organic EL panel. FIGS. 7A and 7B are conceptual views of a multilayer metal mask to be used for deposition of a blue emitting layer or the like of the organic EL panel according to the present invention, and the pixel apertures which are the aperture portions of the insulating film on the transparent substrate forming the organic EL panel. FIGS. 8A and 8B are conceptual views of a multilayer metal mask to be used for deposition of a red emitting layer or the like of the organic EL panel according to the present invention, and the pixel apertures which are the aperture portions of the insulating film on the transparent substrate forming the organic EL panel. FIGS. 9A and 9B are plan views for explaining the state of a failure in deposition on a pixel aperture in accordance with the radius (R) size of a corner portion of a multilayer metal mask according to the present invention. FIG. 9A shows the case where the curvature radius of a corner portion of the multilayer metal mask is not larger than 5 micrometers, and FIG. 9B shows the case where the curvature radius of a corner portion of the multilayer metal mask is large beyond 5 micrometers.

Incidentally, FIGS. 6A-8A are plan views of a multilayer metal mask having small aperture portions serving as the first mask holes 24A and large aperture portions serving as the second mask holes 55, and FIGS. 6B-8B are plan views of aperture portions of the insulating film on the transparent substrate forming the organic EL panel. Here, it is preferable that the curvature radius (hereinafter referred to as “R-size”) of each corner portion of the first mask holes 24A of the multilayer metal mask has a value as close to the R-size of each corner portion of the aperture portions of the insulating film on the transparent substrate forming the organic EL panel as possible. The reason will be described below.

When the R-size of each corner portion of the aperture portions of the insulating film is reduced, the aperture area increases so that the emitting area of each emitting device can be increased, resulting in increase in luminance of the organic EL panel. Therefore, the R-size of each corner portion of the first mask holes 24A shown in FIGS. 6A-8A is set to be approximately as large as the R-size of each pixel aperture or not larger than 5 micrometers. As a result, as shown in FIG. 9A, the R-size of each corner portion of the pixel apertures can be made as small as that of each corner portion of the aperture portions of the insulating film even if misalignment with respect to the pixel apertures 110 occurs in the deposition pattern using the first mask holes 24a of the multilayer metal mask. Thus, lack of deposition to the pixel aperture portions or mixture with other colors can be prevented effectively.

The R-size of each corner portion of the first mask holes 24A is set to be not larger than 5 micrometers for the following reason. Since the pixel apertures are formed by exposure and development using a precision exposure process, the pixel apertures can have an R-size of about 1 micrometer. On the other hand, the metal mask holes are formed by exposure and development using a precision process in the same manner. However, when the resist is peeled off using resist stripper in a process as shown in FIGS. 2E and 2F, an R-size large enough to prevent the resist from being left as a residue in each corner portion of the holes of the metal mask may be required. Thus, there is set a range in which there is no large difference in size from each pixel aperture on the assumption that the R-size is up to 5 micrometers. Based on such a range, the R-size of each metal mask hole is set to be approximately as large as the R-size of each pixel aperture or up to 5 micrometers. In such a manner, the aforementioned excellent effect can be obtained.

On the other hand, assume that the R-size of each corner portion of the first mask holes 24A of the multilayer metal mask is larger than 5 micrometers. In this case, as shown in FIG. 9B, when misalignment with respect to the pixel apertures 110 occurs in the deposition pattern using the first mask holes 24A of the multilayer metal mask, a deposition lack 400 appears in each pixel aperture because the R-size of each corner portion of the first mask holes 24a of the multilayer metal mask is larger than the R-size of each corner portion of the aperture portions of the insulating film. On the other hand, when the R-size of each corner portion of the pixel aperture portions of the insulating film is secured to be large enough to prevent such a deposition lack, the aperture area of each pixel, that is, the open area ratio is reduced as described previously.

Incidentally, the aforementioned multilayer metal mask 100 is produced for pixels of each of the three colors (green, blue and red) in principle. Using a multilayer metal mask 100(a) for deposition of an emitting layer and the like for green pixels as shown in FIG. 6A, a multilayer metal mask 100(b) for deposition of an emitting layer and the like for blue pixels as shown in FIG. 7A and a multilayer metal mask 100(c) for deposition of an emitting layer and the like for red pixels as shown in FIG. 8A, deposition is carried out on aperture portions of the insulating film corresponding to the colors of the multilayer metal masks, that is, pixel apertures 110(a), 110(b) and 110(c) respectively. Incidentally, a system using one mask may be adopted as follows. That is, the mask finishing deposition for one color is displaced to a distance to an adjacent color so as to perform deposition for the adjacent color.

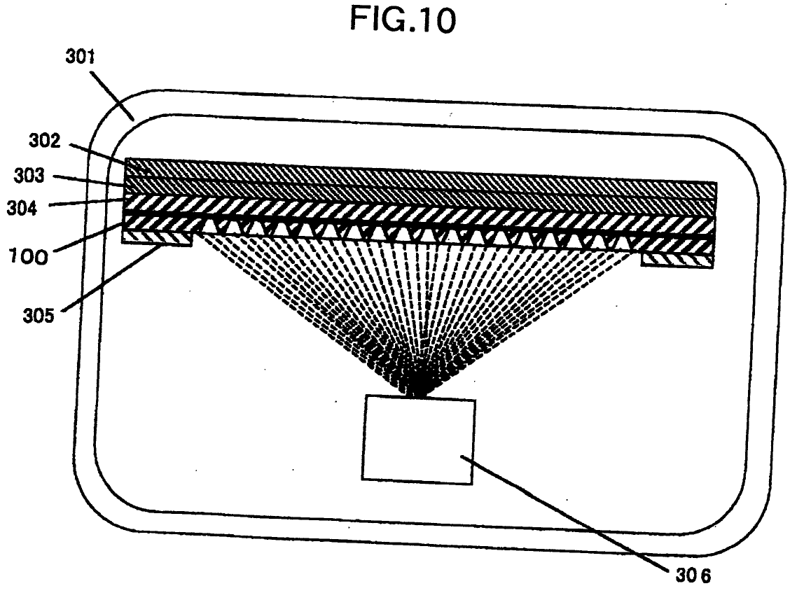

FIG. 10 is an explanatory view of a method for manufacturing an organic EL panel according to the present invention, showing a conceptual view of a deposition apparatus for depositing an emitting layer and the like using the aforementioned multilayer metal mask. The deposition apparatus shown in FIG. 10 has a magnet plate 302 and a deposition source 306 in a deposition tank 301. The magnet plate 302 has a sheet-like shape similar to the organic EL panel. A transparent substrate 304 of the organic EL panel in which thin film transistors and anodes as first electrodes are formed is placed on the magnet plate 302 through a spacer 303. The multilayer metal mask 100 supported by a frame 305 is put on top of the transparent substrate 304. Thus, the transparent substrate 304 is electromagnetically sucked and fixed between the multilayer metal mask 100 and the magnet plate 302.

In this state, materials of an emitting layer and so on, that is, parts or all of a hole transfer layer, a hole injection layer, an organic emitting layer to be formed for each pixel on the hole injection layer, an electron injection layer and an electron transfer layer to be formed and laminated in turn on the organic emitting layer, are deposited from the deposition source 306. The multilayer metal mask 100 is placed so that its large aperture portions serving as the second mask holes are opposed to the deposition source 306. Thus, a deposition region of the emitting layer, the electron transfer layer and so on in each sub-pixel constituting each color pixel is defined by its corresponding first mask hole which is a small aperture portion of the multilayer metal mask 100, and those layers are deposited in accordance with the definition of the first mask hole.

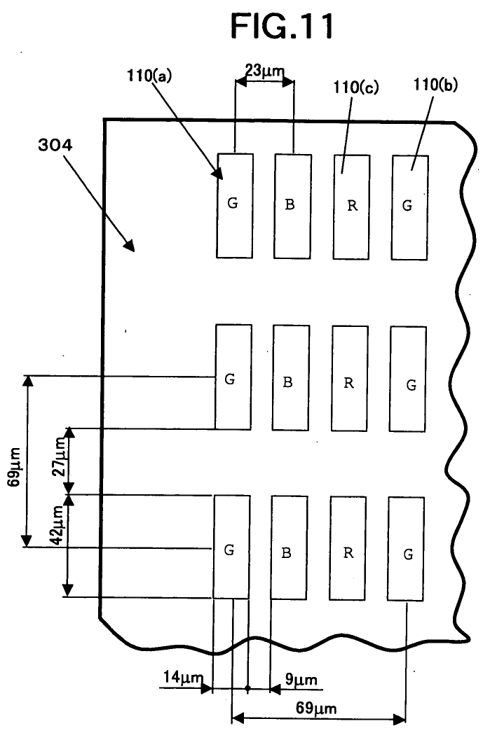

FIG. 11 is a partial plan view of an organic EL panel, showing an example of an array of pixels formed by use of a multilayer metal mask according to the present invention. Using the multilayer metal mask as described above, each pixel can be formed to have a minute-size shape measuring 42 micrometers in length (long side size) by 14 micrometers in width (short side size) as shown in FIG. 11. Thus, it is possible to obtain a high-definition organic EL panel 304 having a pixel pitch which is 69 micrometers in the longitudinal direction and 23 micrometers in the crosswise direction.

Incidentally, although this embodiment has been described on the assumption that a formation system using a deposition method is used, according to another embodiment it is possible to adopt a method in which an emitting layer is formed in a spray coating system using a multilayer metal mask according to the present invention.

Further according to another embodiment, it is also possible to adopt a method in which an emitting layer is formed in a printing system using a multilayer metal mask according to the present invention. After an emitting layer is formed in any one of such various systems, an electron transfer layer is also formed in the same method as the emitting layer, such as a deposition method.

Finally, cathodes serving as second electrodes are formed out of aluminum by deposition. Thus, film formation is terminated. After that, the portion of the organic EL panel including a pixel region, in which portion the aforementioned respective constituent layers have been formed, is sealed off by a sealing can made from glass, plastic or the like and including a drying agent. Thus, the organic EL panel is completed. When a plurality of organic EL panels are produced in a large-size insulating substrate, the insulating substrate is cut into unit organic EL panels one by one. Then, the organic EL panels are completed.

Although the multilayer metal mask according to aforementioned embodiments has a two-layer structure comprised of a first metal layer and a second metal layer, the present invention is not limited to this. A metal layer on the deposition material supply source side may be formed out of two or more sheet materials pasted to each other. In this case, large apertures, that is, second mask holes can be formed in the same manner as in the aforementioned embodiments.

Further, although sub-pixels forming one color pixel for respective colors are arrayed in a straight line in the horizontal or vertical direction of the organic EL panel in the aforementioned embodiments, the present invention is not limited thereto.

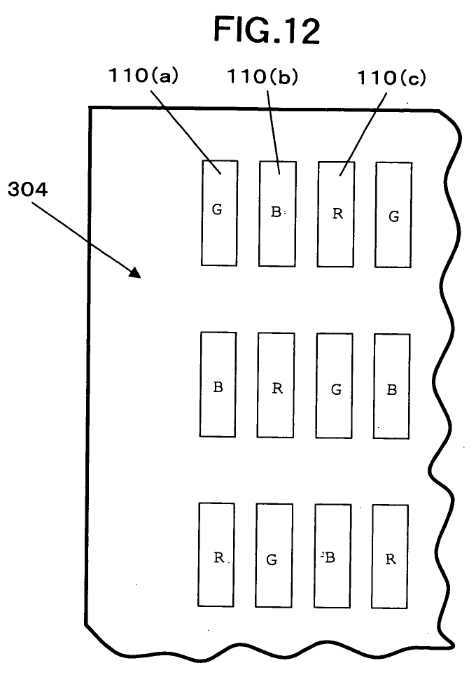

FIG. 12 is a partial plan view of an organic EL panel for explaining another example of an array of sub-pixels constituting a color pixel on an organic EL panel. As shown in FIG. 12, the present invention can be carried out in the arrangement in which green, blue and red sub-pixels 110(a), 110(b) and 110(c) are arrayed obliquely like a zigzag or a delta respectively on an organic EL panel 304.

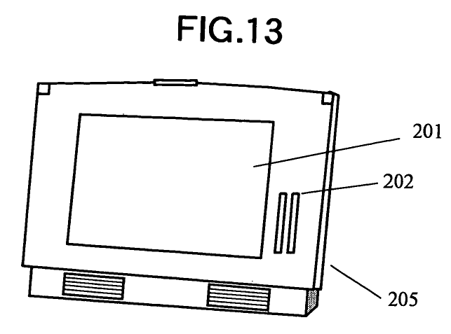

FIG. 13 is an explanatory view of an example of a high-definition organic EL display device in which an organic EL panel manufactured according to the present invention has been incorporated. The reference numeral 201 represents an organic EL panel manufactured using the aforementioned multilayer metal mask. This organic EL panel and various circuit parts such as a drive circuit are incorporated in a housing 202. Thus, a high-definition display device 205 is arranged.

The present invention is not limited to a so-called image monitor as shown in FIG. 13. It is applicable to display devices of various electronics such as various personal computers, portable terminals including portable telephones, television sets, and so on.

While we have shown and described several embodiments in accordance with our invention, it should be understood that disclosed embodiments are susceptible of changes and modifications without departing from the scope of the invention. Therefor, we do not intend to be bound by the details shown and described herein but intend to cover all such changes and modifications a fall within the ambit of the appended claims.

We claim:

1. A method for manufacturing an organic electroluminescence panel including:
a transparent substrate having a first electrode layer and an insulating layer formed on said first electrode layer, said first electrode layer being comprised of pieces formed to correspond to a plurality of pixels and to be driven by active devices respectively, said insulating layer having rectangular apertures corresponding to said pixels respectively, said pieces of said first electrode layer being exposed from said rectangular apertures respectively;
a hole transfer layer and a hole injection layer formed correspondingly to said plurality of pixels so as to be laminated sequentially on said pieces of said first electrode layer through said rectangular apertures;
an organic emitting layer comprised of pieces formed on said hole injection layer correspondingly to said pixels respectively;
an electron injection layer and an electron transfer layer formed to be laminated sequentially on said organic emitting layer; and
a second electrode layer formed on said electron transfer layer over said plurality of pixels in common;
said method comprising the step of:
forming at least one of said organic emitting layer, said electron injection layer and said electron transfer layer out of a deposition material by deposition via mask holes of a multilayer metal mask disposed in close contact with said insulating layer of said transparent substrate;
wherein said multilayer metal mask having a plurality of metal layers of which a metal layer on the side of said transparent substrate and a metal layer on the side of a supply source of said deposition material are different in material, and at least one of said metal layers other than said metal layer on the side of said transparent substrate is made of a thick plate of a magnetic material, while the area of each mask hole of said metal layer on the side of said transparent substrate is equal to or smaller than the area of each mask hole of said metal layer on the side of said supply source of said deposition material.

2. A method for manufacturing an organic electroluminescence panel according to claim 1, wherein in said multilayer metal mask an inner wall of each mask hole of said metal layer on the side of said supply source of said deposition material has a funnel-like shape having a tilt angle not smaller than 30 degrees and not larger than 85 degrees, and open to said supply source of said deposition material.

3. A method for manufacturing an organic electroluminescence panel according to claim 1, wherein in said multilayer metal mask said metal layer on the side of said transparent substrate is thinner than said metal layer on the side of said supply source of said deposition material.

4. A method for manufacturing an organic electroluminescence panel according to claim 1, wherein in said multilayer metal mask said mask holes of said metal layer on the side of said transparent substrate has longitudinal and crosswise sizes corresponding to said pixels respectively, while each mask hole of said metal layer on the side of said supply source of said deposition material has a longitudinal size including a plurality of said pixels in common.

5. A method for manufacturing an organic electroluminescence panel according to claim 1, wherein in said multilayer metal mask said mask holes of said metal layer on the side of said transparent substrate has longitudinal and crosswise sizes corresponding to said pixels respectively, while a curvature radius of each corner portion of said mask holes is not larger than 5 micrometers.

6. An organic electroluminescence panel comprising:
a transparent substrate having a first electrode layer and an insulating layer formed on said first electrode layer, said first electrode layer being comprised of pieces formed to correspond to a plurality of pixels and to be driven by active devices respectively, said insulating layer having rectangular apertures corresponding to said pixels respectively, said pieces of said first electrode layer being exposed from said rectangular apertures respectively;
a hole transfer layer and a hole injection layer formed correspondingly to said plurality of pixels so as to be laminated sequentially on said pieces of said first electrode layer through said rectangular apertures;
an organic emitting layer comprised of pieces formed on said hole injection layer correspondingly to said pixels respectively;
an electron injection layer and an electron transfer layer formed to be laminated sequentially on said organic emitting layer; and
a second electrode layer formed on said electron transfer layer over said plurality of pixels in common;
wherein each short side of said rectangular apertures is not longer than 14 micrometers, while each long side thereof is not longer than 42 micrometers.

7. An organic electroluminescence panel comprising:
a transparent substrate having a first electrode layer and an insulating layer formed on said first electrode layer, said first electrode layer being comprised of pieces formed to correspond to a plurality of pixels and to be driven by active devices respectively, said insulating layer having rectangular apertures corresponding to said pixels respectively, said pieces of said first electrode layer being exposed from said rectangular apertures respectively;
a hole transfer layer and a hole injection layer formed correspondingly to said plurality of pixels so as to be laminated sequentially on said pieces of said first electrode layer through said rectangular apertures;
an organic emitting layer comprised of pieces formed on said hole injection layer correspondingly to said pixels respectively;
an electron injection layer and an electron transfer layer formed to be laminated sequentially on said organic emitting layer; and
a second electrode layer formed on said electron transfer layer over said plurality of pixels in common;
wherein each short side of said rectangular apertures is not longer than 14 micrometers, while each long side thereof is not longer than 42 micrometers;
wherein each piece of said organic emitting layer formed for each pixel on said hole injection layer and each piece of said electron injection layer and electron transfer layer formed and laminated sequentially on said organic emitting layer are larger than each of said rectangular apertures exposing said first electrode layer therefrom, and a curvature radius of each corner portion of said rectangular apertures is not larger than 5 micrometers.

8. An organic electroluminescence panel according to claim 7, wherein a pitch of said pixels formed in said rectangular apertures respectively is not longer than 69 micrometers along the long sides of said rectangular apertures and not longer than 23 micrometers along the short sides of said rectangular apertures.
